(19) United States
(12) Patent Application Publication
(10) Pub. No.: US 2026/0249303 A1
(43) Pub. Date: Aug. 27, 2026

(54) Separating Device in An Agitator Mill, Separating Module and Agitator Mill with A Separating Device

(71) Applicant: NETZSCH-Feinmahltechnik GmbH, Selb (DE)

(72) Inventors: Dennis Linberg, Waldsassen (DE); Holger Möschl, Selb (DE)

(21) Appl. No.: 19/529,279

(22) Filed: Feb. 4, 2026

(30) Foreign Application Priority Data
Feb. 18, 2025 (DE) 10 2025 106 095.9

(51) Int. Cl. B02C 17/16; B02C 17/18; B02C 17/20

(52) U.S. Cl. CPC B02C 17/163; B02C 17/1835; B02C 17/20

(57) ABSTRACT

A separating device in an agitator mill, including a module carrier arranged on a rotating shaft with a carrier frame radially spaced apart from the shaft and at least two separating modules arranged on the carrier frame, with profiles, which are in each case provided on a first and second axial end of the carrier frame, for forming a positive connection with a first and second edge profile of the respective separating modules, wherein the positive connection can be formed after pushing the separating modules onto the carrier frame in the axial direction, a separating module for such a separating device as well as an agitator mill with such a separating device.

### TECHNICAL FIELD

The present invention relates to a separating device in an agitator mill, a separating module of such a separating device and an agitator mill with such a separating device.

### BACKGROUND

Agitator mills serve the purpose of finely and ultra-finely grinding solids in liquids or dry materials. Conventional agitator mills consist of a grinding container, in which an agitator shaft with grinding elements is rotatably mounted. These grinding elements can be formed as fixed disks or striking elements and comminute the grinding material with the help of grinding bodies by means of impact, shearing and frictional forces generated during rotation of the agitator shaft. The mills are used in numerous industries, for example the cement and mineral industry, in the pigment and dye production, in the pharmaceutical industry as well as in the food processing.

The elements of the agitator mill, which directly come into contact with the grinding material and hereby in particular the separating devices for separating solids, which are present in the grinding material, or the grinding bodies used in the grinding process (e.g., balls or cylinders) or the individual elements thereof, respectively, are exposed to high stress and thus increased wear. These elements thus have to be maintained, repaired or replaced frequently. Agitator mills with a modular setup are known, in the case of which the grinding or agitator elements provided as individual modules and the separating device are mounted on an agitator shaft and are fixed there. In order to replace the individual modules and thereby in particular the separating device, a removal and a complete disassembly of the agitator shaft has to take place.

### SUMMARY

It is thus the object of the present invention to create a possibility for maintaining and repairing the separating device in agitator mills, which avoids a complete disassembly of the agitator shaft.

According to the invention, this object is in each case solved by the subject matters of the claims.

According to a first aspect of the invention, a separating device in an agitator mill is provided, comprising a module carrier arranged on a rotating shaft with a carrier frame radially spaced apart from the shaft and at least two separating modules arranged on the carrier frame, with profiles, which are in each case provided on a first and second axial end of the carrier frame, for forming a positive connection with a first and second edge profile of the respective separating modules, wherein the positive connection can be formed after pushing the separating modules onto the carrier frame in the axial direction.

According to a second aspect of the invention, a separating module, in particular for a separating device according to the invention, with a module frame, which can be disassembled, is provided.

According to a third aspect of the invention, an agitator mill with a separating device according to the invention is provided

An idea on which the invention is based lies in providing a modularly set up separating device for an agitator mill, which provides for a simple maintenance and the replacement of individual elements or separating modules, respectively, and which thereby makes the disassembly of the entire agitator shaft superfluous. A secure positioning of the separating modules in the separating device is attained by means of the radial positive connection between the carrier frame and the separating modules, wherein the tangential positive connection ensures a reliable torque transmission. Due to the fact that the modules can be assembled or disassembled by simply being pushed on, a replacement of individual separating modules can be carried out quickly and with little tool usage. The separating modules, which are inherently set up modularly, in turn, provide for the simple replacement of individual parts of the separating modules and avoid that separating modules with defective individual parts have to be replaced as a whole during maintenance or repair.

Advantageous embodiments and further developments follow from the claims, as well as from the description with reference to the figures.

According to one embodiment, it is provided that the profile provided on the first axial end overlaps the first edge profiles for forming a radial positive connection and, for forming a tangential positive connection, has a positive polygonal profiling, which can be engaged with negative polygonal profilings of the first edge profiles, and that the profile provided on the second axial end overlaps the second edge profiles for forming a radial positive connection. A stable positive connection in the radial as well as tangential direction is thus attained in an advantageous manner. The overlap, which extends over the first edge profiles in the axial direction, effectively prevents a slipping of the separating modules in the radial direction, in particular under high centrifugal forces, which occur during operation of the agitator mill. The positive engagement between the positive polygonal profiling of the profile of the module carrier and the negative polygonal profilings of the first edge profiles of the separating modules advantageously ensures a reliable torque transmission. This polygonal toothing ensures a tangential positive connection, which provides for a play-free and non-positive transmission of the torque from the carrier frame to the separating modules. The profile, which is provided on the second axial end of the carrier frame, and which overlaps the second edge profiles of the separating modules, ensures an additional radial positive connection and stabilizes the separating modules along their entire axial length. The construction simultaneously provides for a simple assembly and disassembly of the separating modules being axially pushed on, without the use of complex tools. This leads to a significant reduction of maintenance and standstill times and provides for the modular replacement without disassembly of the entire agitator shaft.

According to one embodiment, it is provided that the edge profiles can be screwed to at least one axial end of the carrier frame. By means of the screw connection of the edge profiles, a mechanical protection of the separating modules is provided, which prevents an unintentional release or slipping of the modules during operation, in particular in the case of high centrifugal forces or vibrations. The combination of positive connection (radial and tangential) on both axial ends of the carrier frame and the non-positive screw connection, in particular on an axial end of the carrier frame, leads to a particularly stable fastening. This is advantageous especially in applications with high torques and changing stresses. The screw-connection also creates the possibility of selectively securing or releasing individual modules, if necessary, without disassembling the entire separating device. The screw connections are thereby positioned so that the respective screws lie outside of the direct contact region with the grinding material. Wear in the screw connections is advantageously reduced hereby.

According to one embodiment, a cover plate is provided, which can be screwed to the axial end, and which covers the edge profile of each separating module and the axial end of the carrier frame, which engages therewith. The arrangement of the cover plate is thereby in particular arranged on the second axial end of the carrier frame and secures the second edge profiles of the separating modules. After the screw connection, the cover plate thereby acts as additional fixation of the separating modules, in that it presses the second edge profile against the second axial end. This prevents an axial shifting of the modules during operation, even in the case of high centrifugal forces or vibrations. By covering the axial end and the edge profile, the cover plate protects the connecting elements lying therebelow, in particular screw connections and contact surfaces, against abrasive wear against grinding material or dirt deposits. The cover plate can additionally take over an additional sealing function, in that it prevents the ingress of grinding material or liquids into the region between carrier frame and separating modules. The screw connection of the cover plate provides for a simple disassembly with little tool usage. This simplifies the access to the separating modules for maintenance or replacement purposes, without the entire separating device having to be disassembled. The cover plate also contributes to the reinforcement of the carrier frame and increases the structural integrity of the entire separating device.

According to one embodiment, the separating modules have a cylindrical or conical fit with the carrier frame and in particular form a jacket surface of the separating device. The cylindrical fit thereby provides for an exact centering of the separating modules on the carrier frame and ensures an even load distribution and stable fastening. The conical fit offers the advantage that the separating modules center themselves when being pushed on. This simplifies the assembly and leads to an automatic alignment of the modules. Due to the conical shape, a release of the modules during the disassembly can take place by means of a simple axial shifting. The conical angle thereby supports the release of the connection. Cylindrical as well as conical fits ensure a high positive connection between carrier frame and separating modules. This ensures a reliable torque transmission, in particular in the case of high mechanical stresses or centrifugal forces during operation.

According to one embodiment, the separating device has more than two separating modules, which are arranged so as to be distributed evenly along the circumference of the module carrier. The modular construction thereby allows adapting the number, position and size of the separating modules to different process requirements in an advantageous manner. Depending on the separating method, modules can be removed or adapted selectively, without having to convert the entire device. The individual stress of the separating modules is reduced by means of the distribution of the occurring forces to more than two modules.

According to one embodiment, the separating device is formed as cylinder. The cylindrical shape provides for an even distribution of the centrifugal forces during operation of the agitator mill. This advantageously leads to a reduced mechanical stress of the separating modules and of the carrier frame. The cylindrical setup ensures a homogenous flow of the grinding material around the separating modules. This improves the efficiency of the separation because the grinding material is distributed evenly over the entire separating surface. The cylindrical geometry lends a high structural stability to the separating device, which proves to be advantageous in particular in the case of high rotational speeds or intensive mechanical stresses.

According to an alternative embodiment, the separating device is formed as cone, wherein the separating modules have a trapezoidal outer contour. The conical shape of the separating device supports a centering of the separating modules when being pushed on. The trapezoidal outer contour of the modules is thereby adapted to the conical structure, whereby a precise alignment is attained without additional adjusting effort. The conical setup of the separating device advantageously influences the flow guidance of the grinding material, in that the material is guided in a controlled manner to the center or to the edge. This optimizes the separating process and leads to a more efficient material processing. The combination of conical shape of the separating device and trapezoidal module contour ensures a positive fit of the modules, which reliably transmits radial as well as tangential forces. Due to the conical fit, the separating modules can be released by means of a simple axial shifting. The trapezoidal separating modules provide for a gap-free arrangement along the cone and thus ensure a maximum utilization of the available separating surface.

According to one embodiment, at least one radially protruding grinding or agitator element is provided, which is arranged in the carrier frame or the separating modules. The radially protruding grinding or agitator element on the separating device ensures a homogenization of the grinding material prior to the discharge from the agitator mill. The radially protruding elements influence the flow dynamic of the grinding material in that they actively guide the material through the grinding chamber and to the separating device. This prevents dead zones and material accumulations in the region of the separating device and improves the grinding material discharge. It goes without saying that the invention is not limited to embodiments with only one grinding or agitator element, which is assigned to each separating module, but an adaptation of the number to the respective process requirements can be made. It is also possible to vary the size and shape of the grinding or agitator elements in order to adapt the process to different grinding material types or comminution requirements.

According to one embodiment of the separating module according to the invention, at least one element is provided, which is arranged in the module frame and which is formed as lamella, rod or strip, wherein in a further development, the element is preferably arranged so as to be aligned parallel, orthogonally or obliquely to a longitudinal axis of the separating module and so as to be held in the separating module via edge profiles of the module frame. The possibility of aligning the element at different angles (parallel, orthogonally or obliquely) to the longitudinal axis allows for an adaptation to different process requirements. As a function of the intended material flow or separating behavior, the number and/or alignment of the elements can be selected selectively in order to optimize the efficiency of the separating device. The flow dynamic within the agitator mill can advantageously be controlled via the variable alignment of the elements. Elements arranged in parallel thereby promote an even material flow, while elements aligned orthogonally or obliquely provide for a mixing and selective guidance of the material flow. Due to the geometric flexibility of the elements, the separating process can thus be controlled according to the process requirements and the grinding material types. The fastening of the elements via edge profiles in the module frame ensure a secure hold and a stable positioning. This prevents a slipping during operation and ensures a reliable separating performance even under high mechanical stress. The setup of the separating modules, which is inherently modular and which can be disassembled, and the fastening of the elements via edge profiles provides for a replacement of individual elements in the case of wear or damage, without having to replace the entire separating module.

According to a further development of the separating module, at least one screen is provided, which is releasably inserted in the module frame, wherein the screen can be arranged so as to lie radially externally or radially internally in the module frame, in particular can be screwed to the latter. The release screen insert provides for a quick replacement in the case of wear or clogging, without the entire separating module having to be disassembled or replaced. This reduces standstill times and lowers the maintenance costs. The possibility of arranging the screen insert so as to lie either radially externally or radially internally allows for a flexible adaption to different process requirements and grinding materials. Screens lying externally increase the separating surface and are suitable, for example, for coarse separating processes, while screens lying internally can be used for finer separating processes. An arrangement of the screen on the carrier frame or module carrier of the separating device, i.e., independently of the separating module, is likewise comprised by the invention.

According to one embodiment, the separating module is formed as screen module or classifier module. The possibility of forming the separating module as screen module or classifier module allows for an adaption of the separating device to different separating requirements. While the screen module is suitable for the mechanical separation according to particle size, the classifier module uses fluidic principles in order to separate fine from coarse particles. The selection between screen and classifier module can thus be used in an advantageous manner for controlling the particle size distribution in the end product. A defined screen width in the grinding material can be set by means of the screen module, while the classifier module offers the opportunity of dynamically changing the separating cut by adapting flow speed and air flow. The modular design of the separating device and of the separating modules makes it possible, depending on the grinding process or grinding material type, to select the suitable separating module or also allows permits combined separating methods, i.e., screening with simultaneous classification.

In terms of the present invention, “classifiers” are to be understood to be agitator mills, in which a separating element classifies particles based on their size and density by means of air flow or other fluid dynamics principles. Lighter and finer particles are thereby entrained and separated by the air flow, while heavier or coarser particles remain in the grinding process due to their inertia. Classifier modules are used in particular in order to attain a finer separation than would be possible with mechanical screens. The separating efficiency of the classifier can thereby be regulated by adapting the air flow speed or the pressure, whereby a dynamic control of the separating process is made possible.

According to one embodiment of the agitator mill, the latter comprises a cylindrical grinding container with a grinding material outlet, wherein the separating device is assigned to the grinding material outlet. The arrangement of the separating device in the region of the grinding material outlet provides for a selective separation of the grinding material from entrained coarse particles or grinding bodies, before it leaves the grinding container. Due to the direct positioning of the separating device at the outlet, coarse material, which has not reached the desired particle size, can be returned directly into the grinding process. The separating device at the grinding material outlet ensures a continuous material flow and prevents deposits or clogging at the outlet.

Where useful, the above embodiments and further developments can be combined arbitrarily with one another. Further possible embodiments, further developments and implementations of the invention also comprise combinations, which have not been mentioned explicitly, of features of the invention, which have been described above or which will be described below with regard to the exemplary embodiments. The person of skill in the art will thereby in particular also add individual aspects as improvements or additions to the respective basic shape of the present invention.

### BRIEF DESCRIPTION OF THE DRAWINGS

The present invention will be explained in more detail below on the basis of exemplary embodiments with reference to the enclosed figures of the drawings.

In the figures:

FIG. 1 shows a perspective sectional illustration of a separating device according to an exemplary embodiment of the invention;

FIG. 2 shows a perspective exploded illustration of a separating module according to an exemplary embodiment of the invention;

FIG. 3 shows a perspective illustration of a separating device according to an exemplary embodiment of the invention and

FIG. 4 shows a schematic illustration of the arrangement of a separating module in a separating device according to an exemplary embodiment of the invention.

### DETAILED DESCRIPTION

Elements, features and components, which are identical, functionally identical and which act identically, are in each case provided with the same reference numerals in the figures of the drawing – unless otherwise specified.

Even though specific embodiments and further developments are illustrated and described herein, the person of skill in the art will prefer that a plurality of alternative and/or similar embodiments can replace the illustrated and described specific exemplary embodiments, without turning away from the scope of the present invention. This application is to generally cover all modifications or changes of the specific exemplary embodiments described herein.

The enclosed figures are to provide a further understanding of embodiments of the invention and, in connection with the description, serve the purpose of explaining principles and concepts of the invention. Other exemplary embodiments and many of the mentioned advantages result with regard to the drawings. The drawings are to be understood only as schematic drawings and the elements of the drawings are not necessarily illustrated true to scale to one another. Directional terminology, such as, for instance “top”, “bottom”, “left”, “right”, “above”, “below”, “horizontal”, “vertical”, “front”, “rear” and similar information is used only for explanatory purposes and do not serve to limit the generality to specific designs, as shown in the figures.

Dashed lines in the figures of the drawings clarify that the connections between the components connecting the dashed lines do not mandatorily have to have physical contact with one another but can likewise be coupled wirelessly with one another.

The exemplary embodiments have been selected and described in order to be able to illustrate the principles on which the invention is based and its applications in practice in the best possible way. Persons of skill in the art can thus optimally modify and use the invention and its different exemplary embodiments with regard to the intended purpose. The terms “including” and “having” are used as neutral terminology for the corresponding terms “comprising” in the claims as well as the description. A use of the terms “a” and “an” is to furthermore not generally rule out a plurality of features and components described in this way.

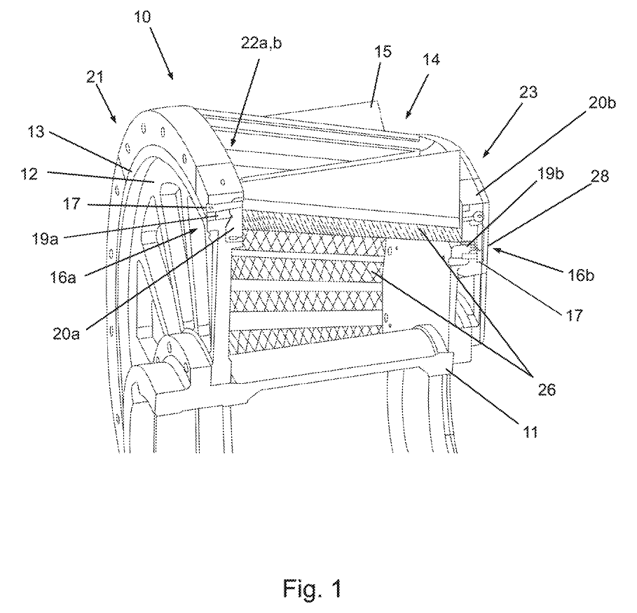

FIG. 1 shows a perspective sectional illustration of a separating device 10 according to an exemplary embodiment of the invention. The separating device 10 comprises a module carrier 12, which is arranged on a rotating hub 11 and which has a carrier frame 13, which is radially spaced apart from the hub 11. Several separating modules 14, which serve the purpose of separating the grinding material via screens 26 inserted in the separating modules 14, are arranged on the carrier frame 13.

In the shown exemplary embodiment, each separating module 14 is provided with an agitator element 15, which protrudes into the grinding chamber of the agitator mill and contributes to the selective guidance and mixing of the grinding material. The agitator element 15 is an integral part of the separating module 14 and is oriented outwards in the radial direction. It goes without saying that embodiments without or with only few agitator elements 15 are also possible.

The fastening of the separating modules 14 to the carrier frame 13 takes place via a combination of positive connections 16a, b and mechanical fastening elements 17. The positive connections 16a, b are established via specifically shaped profiles 19a, b on the carrier frame 13 and corresponding edge profiles 20a, b on the separating modules 14. A profile 19a, which overlaps the edge profiles 20a of the separating modules 14 arranged the first axial end 21, is provided on the first axial end 21 of the carrier frame 13. This overlap ensures a radial positive connection, which reliably holds the separating module 14 in its position and prevents a slipping in the radial direction. On the first axial end 21 of the carrier frame 13, the profile 19a additionally has a positive polygonal profiling 22a, which can be engaged there with a corresponding negative polygonal profiling 22b of the edge profiles 20a of the separating modules 14. This polygonal toothing ensures a tangential positive connection, which provides for a reliable torque transmission from the carrier frame 13 to the separating modules 14. A profile 19b, which overlaps the edge profiles 20b of the separating modules 14 and thus establishes a further radial positive connection, is likewise provided on the second axial end 23 of the carrier frame 13. After pushing the separating module 14 onto the carrier frame 13 and positive locking, a fastening by means of the fastening elements 17, such as, for example, by means of screws or similar mechanical elements, which act in a non-positive manner and which also secure the separating module 14 in the axial direction, additionally takes place here. In order to reduce wear, the fastening elements 17 are covered on the second axial end 23 by means of a screwed-on cover plate 28. A securing, which is not illustrated in FIG. 1, can alternatively or additionally take place by means of further securing means, such as, for example, a pinning between the edge profiles 20a, b and the carrier frame 13, on both axial ends 21, 23, wherein pins, which are provided or can be inserted, for example, on the edge profiles, are plugged or inserted into corresponding bores in the carrier frame 13.

The separating device 10 has a modular construction with secure fastening of the separating modules 14, which is attained by means of the combination of radial and tangential positive connection as well as mechanical screw connection. The positive connections 16a, b ensure a stable and play-free assembly of the separating modules 14, while the fastening provides for a simple assembly and disassembly as well as maintenance of the separating modules 14.

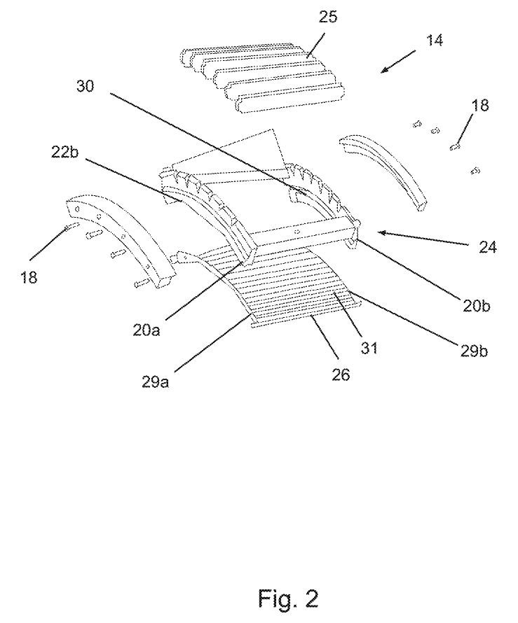

FIG. 2 shows a perspective exploded illustration of a separating module 14 according to an exemplary embodiment of the invention. The separating module 14 is set up in a modular manner and can be disassembled completely, so that the individual components can be replaced or maintained, if necessary. The separating module 14 comprises a module frame 24, which serves as supporting structure and which provides for the fastening of the further components. In the installed state, the module frame 24 is connected to the carrier frame 13 of the separating device 10 via the positive connections 16a, b, which are described in connection with FIG. 1. This positive connection 16a, b takes place via the profiles 19a, b on the carrier frame 13 of the separating device and corresponding edge profiles 20a, b on the separating modules 14, which ensure a secure hold by overlapping by the profiles 19a, b on the carrier frame 13 and polygonal profilings 22a, b on carrier frame 13 and separating module 14. Several lamellae 25, which serve the purpose of stabilizing the module frame 24, are arranged in the interior of the module frame 24. In some embodiments, which are not shown here, the lamellae 25 can also form support elements for the screen 26. The screen 26 can be assembled so as to lie radially externally as well as radially internally ion the module frame 24. For this purpose, opposite edges 29a, b of the screen 26 are inserted, for example, into grooves 30 provided internally in the edge profiles 20a, b and are screwed to the edge profiles 20a, b. The position of the grooves 30 thereby defines the distance of the screen surface 31 from the lamellae 25. The screen 26 has different hole widths and hole numbers, which can be selected depending on the desired particle size and separating efficiency. By means of the modular construction of the separating module 14, the replacement of the screen 26 as well as of the lamellae 25 is possible at any time, without the entire separating module 14 having to be dismantled into individual parts. In order to fix the individual components, the separating module 14 is provided with several screws 18. Said screws provide for a quick and simple assembly and disassembly of the components.

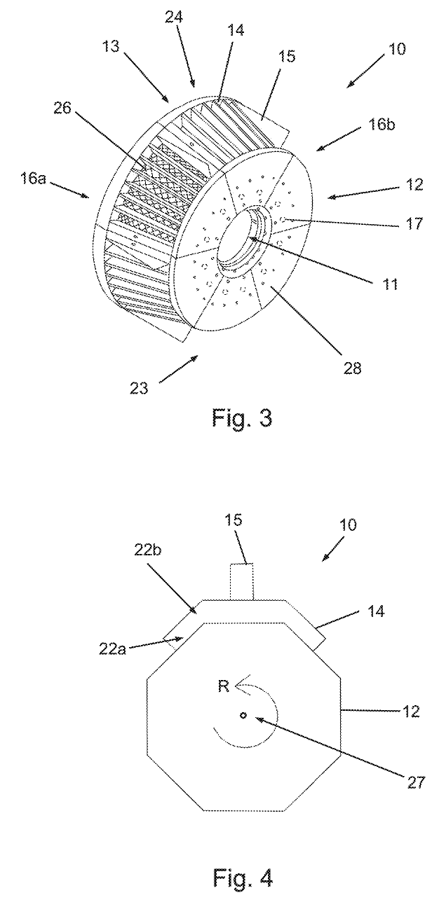

FIG. 3 shows a perspective illustration of a separating device 10 according to an exemplary embodiment of the invention. The separating device 10 has a module carrier 12 and can be clamped with a rotating hub 11 of an agitator mill. The module carrier 12 comprises a carrier frame 13, which is radially spaced apart from the shaft and on which several separating modules 14 are arranged evenly along the circumference. The separating modules 14 in each case consist of a module frame 24, on which an agitator element 15 as well as a screen 26 are integrated in each case. The agitator elements 15 are oriented externally in the radial direction and serve the purpose of mixing and guiding the grinding material. The screens 26 are releasably fastened in the module frame 24, for example screwed or latched. The screens 26 separate the grinding material by particle size and retain coarse particles or grinding bodies. The screens 26 can be embodied with different hole widths and hole numbers and can be assembled so as to be turned, if necessary. In the assembled state, the fastening of the separating modules 14 to the carrier frame 13 takes place via the positive connections 16a, b, which have been described in more detail in connection with FIG. 1. In FIG. 3, screwed-on cover plates 28 cover the profiles 19b on the carrier frame 13 and corresponding edge profiles 20b on the separating modules 14. The profiles 19a, b of the carrier frame 13 overlap the edge profiles 20a, b of the separating modules 14 and ensure a radial positive connection. The profiles 19a are additionally provided with positive polygonal profilings 22a, which are engaged with the negative polygonal profilings 22b of the edge profiles 20a when pushing the separating modules 14 onto the carrier frame 13, in order to establish a tangential positive connection and thus a reliable torque transmission. In order to further secure the separating modules 14, fastening elements 17, such as screws, for example, which are covered by the cover plates 28 in FIG. 3, are provided on the axial end 23 of the carrier frame 13. Said fastening elements ensure a reliable fixation of the separating modules 14 in the axial direction and simultaneously provide for a simple disassembly of the separating modules 14 for maintenance or replacement purposes. Due to the fact that the fastening elements 17 do not lie directly in the grinding material stream, they have a reduced wear and thus longer service lives.

FIG. 4 shows a schematic illustration of the arrangement of a separating module 14 in a separating device 10 according to an exemplary embodiment of the invention. In the use state, several separating modules 14 are arranged so as to be distributed around the entire circumference of the module carrier 12. The separating module 14 is assembled on the rotating module carrier 12. In the use state, the module carrier 12 rotates together with the separating modules 14 fastened thereto around a central axis of rotation 27 in the direction of rotation indicated by the directional arrow R. A rotation in the opposite direction is likewise possible. In the exemplary embodiment, the separating module 14 additionally comprises an agitator element 15, which protrudes radially outwards from the module carrier 12. The agitator element 15 is an integral part of the separating module 14 and serves the purpose of processing the grinding material by means of mechanical impact during the rotation and of the grinding stream guidance in the separating device 10. The positive connection between the module carrier 12 and the separating module 14 via polygonal profilings 22a, b is illustrated in a highly schematic manner in FIG. 4. The positive polygonal profiling 22a on the module carrier 12 engages with the negative polygonal profiling 22b of the separating module 14. This polygonal structure provides for a play-free connection between separating module 14 and module carrier 12 and a tangential positive connection, by means of which the torque is transmitted reliably from the modular carrier 12 to the separating module 14. The positive connection thereby prevents a rotation of the separating module 14 relative to the module carrier 12 and holds the separating module 14 in the provided position in the separating device 10 in cooperation with the further positive connections described in connection with the preceding figures. An octagonal design is shown in FIG. 4. The invention is not limited thereto. Embodiments of the polygonal profilings 22a, b with more or fewer corners are also possible.

Different features have been combined in the preceding detailed description in order to improve the stringency of the illustration in one or several examples. It should be clear thereby, however, that the above description is only of an illustrative, but in no way of a limiting nature. It serves to cover all alternatives, modifications and equivalents of the different features and exemplary embodiments. Many other examples will be clear immediately and directly to the person of skill in the art based on his expert knowledge in consideration of the above description.

1. A separating device in an agitator mill, comprising a module carrier arranged on a rotating hub with a carrier frame radially spaced apart from the hub and at least two separating modules arranged on the carrier frame, with profiles, which are in each case provided on a first and second axial end of the carrier frame, for forming a positive connection with a first and second edge profile of the respective separating modules, wherein the positive connection can be formed after pushing the separating modules onto the carrier frame in the axial direction.

2. The separating device in an agitator mill according to claim 1, wherein the profile provided on the first axial end overlaps the first edge profiles for forming a radial positive connection and, for forming a tangential positive connection, has a positive polygonal profiling, which can be engaged with negative polygonal profilings of the first edge profiles, and the profile provided on the second axial end overlaps the second edge profiles in a claw-like manner for forming a radial positive connection.

3. The separating device in an agitator mill according to claim 1, wherein the edge profiles are screwed to at least one of the axial ends.

4. The separating device in an agitator mill according to claim 1 wherein a cover plate is provided, which can be screwed to the second axial end, and which covers the second edge profile and the second axial end.

5. The separating device in an agitator mill according to claim 1, wherein the separating modules have a cylindrical or conical fit with the carrier frame and in particular form a jacket surface of the separating module.

6. The separating device in an agitator mill according to claim 1, wherein the separating device has more than two separating modules, which are arranged so as to be distributed evenly along the circumference of the module carrier.

7. The separating device in an agitator mill according to claim 1, wherein the separating device is formed as cylinder.

8. The separating device in an agitator mill according to claim 1, wherein the separating device is formed as cone and the separating modules have a trapezoidal outer contour.

9. The separating device in an agitator mill according to claim 1, wherein at least one radially protruding grinding or agitator element is provided, which is arranged in the carrier frame or the separating modules.

10. A separating module, in particular for a separating device in an agitator mill comprising a module carrier arranged on a rotating hub with a carrier frame radially spaced apart from the hub and at least two separating modules arranged on the carrier frame, with profiles, which are in each case provided on a first and second axial end of the carrier frame, for forming a positive connection with a first and second edge profile of the respective separating modules, wherein the positive connection can be formed after pushing the separating modules onto the carrier frame in the axial direction, the separating module having a module frame which can be disassembled.

11. The separating module according to claim 10, wherein at least one element is provided, which is arranged in the module frame, and which is formed as lamella, rod or strip.

12. The separating module according to claim 11, wherein the at least one element is arranged so as to be aligned parallel, orthogonally or obliquely to a longitudinal axis of the separating module and so as to be held in the separating module via edge profiles of the module frame.

13. The separating module according to claim 10, wherein at least one screen is provided, which is releasably inserted in the module frame and wherein the screen can be arranged so as to lie radially externally or radially internally in the module frame, in particular can be screwed to the module frame.

14. The separating module according to claim 10, wherein the separating module is formed as screen module or classifier module.

15. An agitator mill with a separating device comprising a module carrier arranged on a rotating hub with a carrier frame radially spaced apart from the hub and at least two separating modules arranged on the carrier frame, with profiles, which are in each case provided on a first and second axial end of the carrier frame, for forming a positive connection with a first and second edge profile of the respective separating modules, wherein the positive connection can be formed after pushing the separating modules onto the carrier frame in the axial direction.

16. The agitator mill with a separating device according to claim 15, comprising a cylindrical grinding container with a grinding material outlet, wherein the separating device is assigned to the grinding material outlet.

17. The separating device in an agitator mill according to claim 2, wherein the edge profiles are screwed to at least one of the axial ends.

18. The separating device in an agitator mill according to claim 2 wherein a cover plate is provided, which can be screwed to the second axial end, and which covers the second edge profile and the second axial end.

19. The separating device in an agitator mill according to claim 2, wherein the separating modules have a cylindrical or conical fit with the carrier frame and in particular form a jacket surface of the separating module.

20. The separating device in an agitator mill according to claim 2, wherein the separating device has more than two separating modules, which are arranged so as to be distributed evenly along the circumference of the module carrier.
